(19) United States
(12) Patent Application Publication
(10) Pub. No.: US 2011/0198414 A1
(43) Pub. Date: Aug. 18, 2011

(54) PAINT SPRAYER AND PAINT CONTAINER ADAPTER

(76) Inventors: Jamie S. Munn, Maitland (CA); James D. Marshall, Gananoque (CA); Stacey Black, Stittsville (CA); David J. Timan, Sydenham (CA); Corey D. MacTavish, Nepean (CA); Robert J.B. Hobden, Kingston (CA); Oleksiy P. Sergyeyenko, Ottawa (CA)

(21) Appl. No.: 12/948,259

(22) Filed: Nov. 17, 2010

Related U.S. Application Data
(60) Provisional application No. 61/261,953, filed on Nov. 17, 2009.

(51) Int. Cl. B05B 9/00; B65B 3/12

(52) U.S. Cl. 239/332; 239/375; 141/60; 141/7

(57) ABSTRACT

A sprayer that delivers a pattern of paint that can be obtained from a container. The sprayer generally includes a sprayer body that emits the pattern with the paint. The sprayer also includes a reservoir including a cavity that when connected thereto provides the paint to the sprayer body. The reservoir includes a cylinder and a piston assembly manually movable in the cylinder to draw the paint into the cylinder when the reservoir is connected to the container.

### CROSS-REFERENCE TO RELATED APPLICATIONS

This application claims the benefit of U.S. Provisional Application No. 61/261,953, filed on Nov. 17, 2009. The entire disclosure of the above application is incorporated herein by reference.

### FIELD

The present disclosure relates to a sprayer for spraying fluids including paints and stains and a reservoir body for holding such liquids.

### BACKGROUND

This section provides background information related to the present disclosure which is not necessarily prior art.

Typically, when changing paint in a paint sprayer, a reservoir of paint is emptied and cleaned before different paint is introduced. Cleaning the reservoir can expose the sprayer body and pump to the cleaning process. Filling the reservoir with paint can also be a messy process.

### SUMMARY

This section provides a general summary of the disclosure, and is not a comprehensive disclosure of its full scope or all of its features.

The present teachings generally include a sprayer that delivers a pattern of paint that can be obtained from a container. The sprayer generally includes a sprayer body that emits the pattern with the paint. The sprayer also includes a reservoir including a cavity that when connected thereto provides the paint to the sprayer body. The reservoir includes a cylinder and a piston assembly manually movable in the cylinder to draw the paint into the cylinder when the reservoir is connected to the container.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of certain aspects of the present teachings and not all possible implementations, and are not intended to limit the scope of the present teachings.

FIG. 1 is a side elevation view of a sprayer constructed in accordance with the present teachings.

FIG. 2 is a perspective view of a reservoir body of the sprayer of FIG. 1 constructed in accordance with the present teachings.

FIG. 3 is an exploded perspective view of the reservoir body of FIG. 2 constructed in accordance with the present teachings.

FIG. 4 is a partial cross-sectional view of a portion of the sprayer of FIG. 1 illustrating the reservoir body connected to the sprayer body and constructed in accordance with the present teachings.

FIGS. 5 and 6 are perspective views of a container adapter to facilitate adding liquid to the reservoir body in accordance with the present teachings.

FIG. 7 is a partial perspective view illustrating the attachment of the container adapter of FIG. 6 to a paint container constructed in accordance with the present teachings.

FIG. 8 is a perspective view illustrating the container adapter of FIG. 6 coupled to the paint container and employed to guide a stream of liquid dispensed from the paint container adapter through a pour port that is constructed in accordance with the present teachings.

FIGS. 9 and 10 are partial perspective views illustrating the use of the container adapter of FIG. 6 with the reservoir body of FIG. 2 in accordance with the present teachings.

FIGS. 11, 12, 13, and 14 are perspective views illustrating further examples of means for coupling a reservoir to a sprayer body constructed in accordance with the present teachings.

FIGS. 15 and 16 are exploded perspective views illustrating further examples of means for coupling a reservoir to a sprayer body constructed in accordance with the present teachings.

Corresponding reference numerals indicate corresponding parts throughout the several views of the drawings.

### DETAILED DESCRIPTION

Example aspects of the present teachings will now be described more fully with reference to the accompanying drawings.

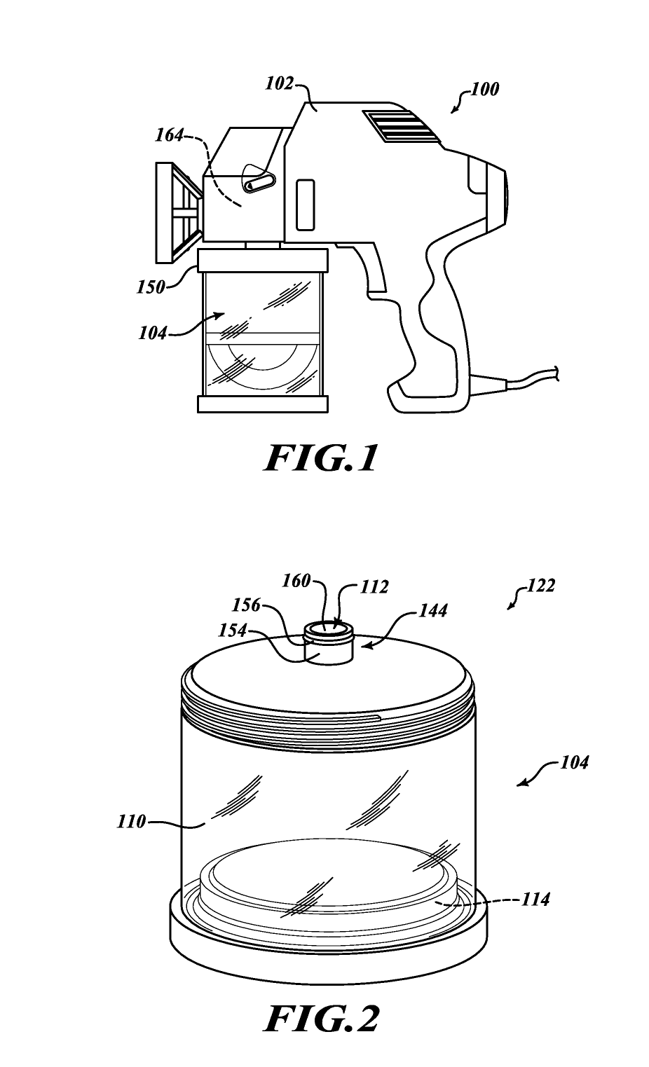

With reference to FIGS. 1 and 2, a sprayer constructed in accordance with the present teachings is generally indicated by reference numeral 100. The sprayer 100 can include a sprayer body 102 and a reservoir 104 that can be removably coupled to the sprayer body 102. With reference to FIGS. 2, 3, and 4, the reservoir 104 can comprise a cylinder 110, a valve assembly 112, and a piston assembly 114.

The cylinder 110 can comprise a cylinder structure 120, an upper cap member 122, and a threaded ring 124. The cylinder structure 120 can be unitarily formed, but in the example provided, can include a cylinder member 130 and an externally threaded ring member 132 that can be fixedly coupled to a lower end of the cylinder member 130. The cylinder member 130 can be formed of a transparent plastic material, such as an acrylic plastic, which can permit the user of the sprayer 100 to determine the extent to which a cavity 134 of the cylinder structure 120 is filled with paint (or other suitable liquid) that is to be dispensed from the sprayer 100.

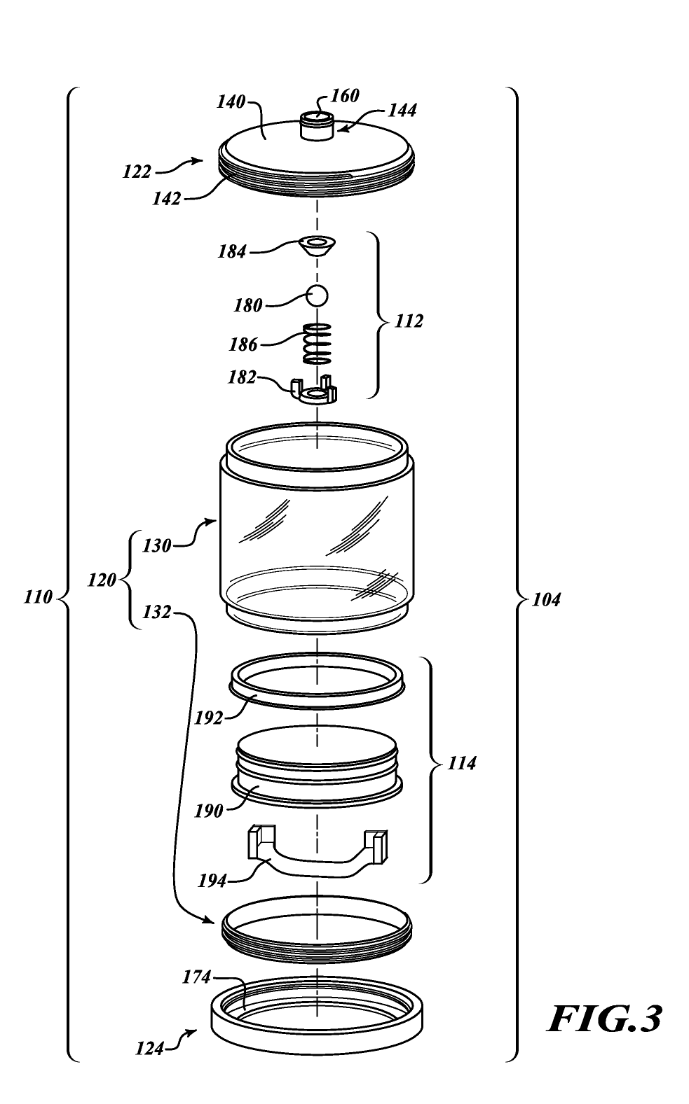

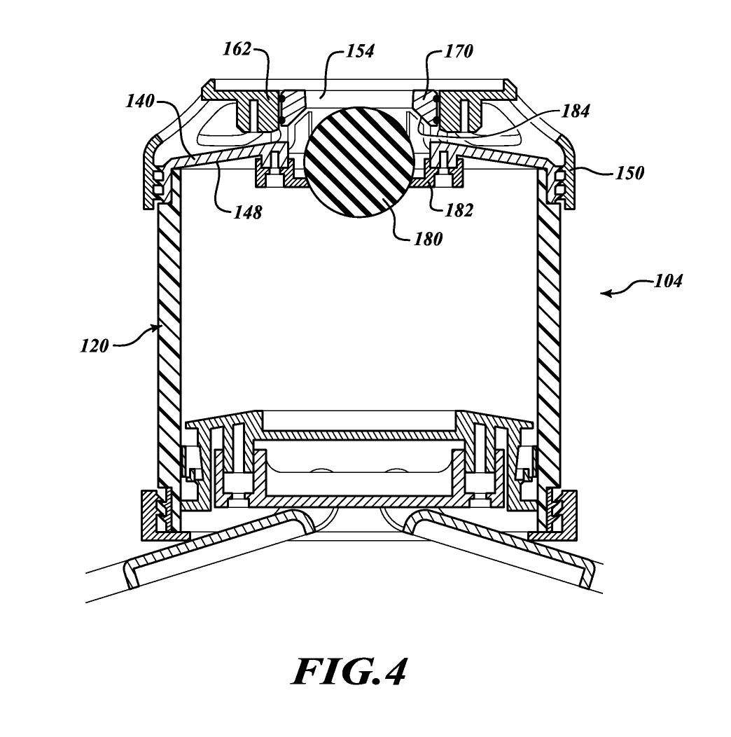

With reference to FIGS. 3 and 4, the upper cap member 122 can be fixedly coupled to an upper end 136 of the cylinder member 130. The upper cap member 122 can include an end member 140, a threaded exterior mount 142, and a coupling neck 144. The end member 140 can be contoured on its interior surface 148 in a desired manner to permit air within the cylinder structure 120 to collect immediately below the coupling neck 144. In the example, the interior surface 148 can be tapered toward the coupling neck 144 (i.e., the interior surface 148 can be frusto-conically shaped with the narrower end of the frusto-conical shape extending in a direction away from the cylinder member 130). It will appreciated in light of the disclosure that other shapes, such as a spherical radius, can also be shown to be effective in collecting air within the cylinder structure 120 below the coupling neck 144.

The threaded exterior mount 142 can be integrally formed with the end member 140 and can extend about the outer circumferential surface of the upper cap member 122. The threaded exterior mount 142 can comprise a plurality of threads that can be threadably engaged to a collar 150 of the sprayer body 102 to couple (and uncouple) the reservoir 104 to the sprayer body 102. The coupling neck 144 can include a neck structure 154 and one or more seal members 156. The neck structure 154 can define an outlet port 160 that can be employed to discharge paint contained in the reservoir 104. The neck structure 154 can be a tubular member that can extend from the end member 140 and can be configured to engage and establish a fluid connection with an inlet 162 of a pump assembly 164 in the sprayer body 102

In one example, a single seal member 170 (e.g.: an o-ring, or a lip seal) is received in a groove 172 in the neck structure 154 and can form a seal between an exterior surface of the neck structure 154 and an interior surface of the inlet 162 of the pump assembly 164. It will be appreciated in light of the disclosure that the inlet 162 can be contoured (e.g.: tapered, or rounded) to permit the coupling neck 144 to be introduced to the inlet 162 without sealing engagement and thereafter sealing engagement can be produced when the coupling neck 144 is translated into (or further translated into) the inlet 162 by threading the collar 150 onto the threaded exterior mount 142.

The threaded ring 124 can be threadably engaged to the externally threaded ring member 132 and can include an annular abutment 174 that can be employed to restrict movement of the piston assembly 114 in a direction away from the upper cap member 122. It will be appreciated in light of the disclosure that removal of the threaded ring 124 from the externally threaded ring member 132 can permit the piston assembly 114 to be removed from the cylinder member 130.

The valve assembly 112 can comprise a valve element 180 that can be moved between a closed position and an open position to selectively vent air from the cylinder 110, discharge liquid from the cylinder 110, or draw liquid into the cylinder 110 or both. In one example, the valve element 180 can be a hollow ball and the valve assembly 112 further comprises a ball cage 182 and a valve seat 184. The ball cage 182 can be fixedly coupled to the upper cap member 122 and can be configured to confine the movement of the valve element 180 within a predetermined range. The valve seat 184 can be a separate component as is illustrated, or can be integrally formed with the upper cap member 122. The valve seat 184 can be configured to engage the valve element 180 to close the outlet port 160. In some instances, the valve assembly 112 can further comprise an elastic element, such as a spring 186 that can bias the valve element 180 in a direction toward the valve seat 184, i.e., in a direction that closes the outlet port 160.

The piston assembly 114 can comprise a piston 190, a seal system 192, and a handle 194. The piston 190 can be received in the cylinder member 130 for translation between the upper cap member 122 and the annular abutment 174. The seal system 192 can comprise one or more seal members 196 that can be received between the piston 190 and an interior surface of the cylinder member 130. In one example, the seal system 192 comprises a single seal member 196 having a pair of lip seals 198. The handle 194 can be coupled to a side of the piston 190 opposite the upper cap member 122 and can be employed to permit the user of the sprayer 100 to manually move the piston 190 within the cylinder 110.

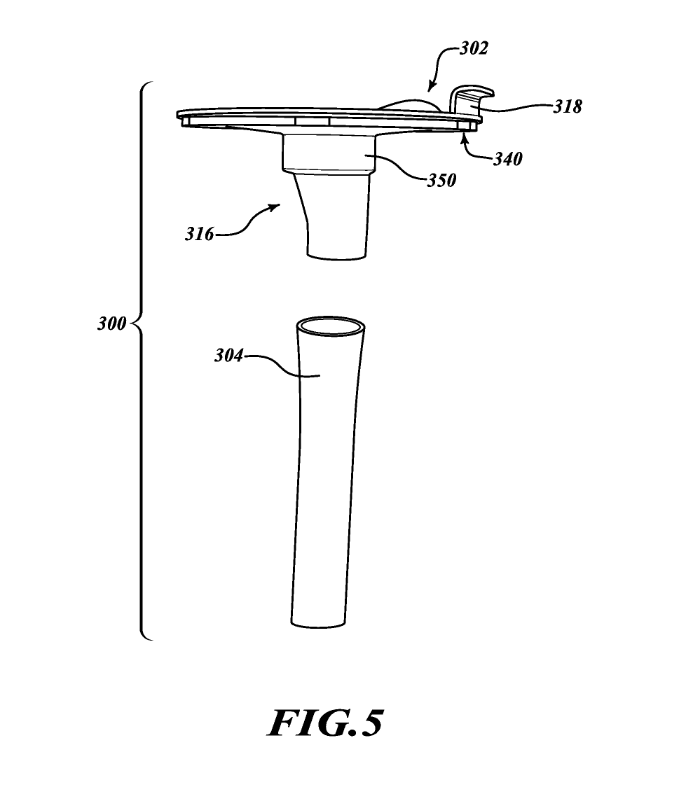

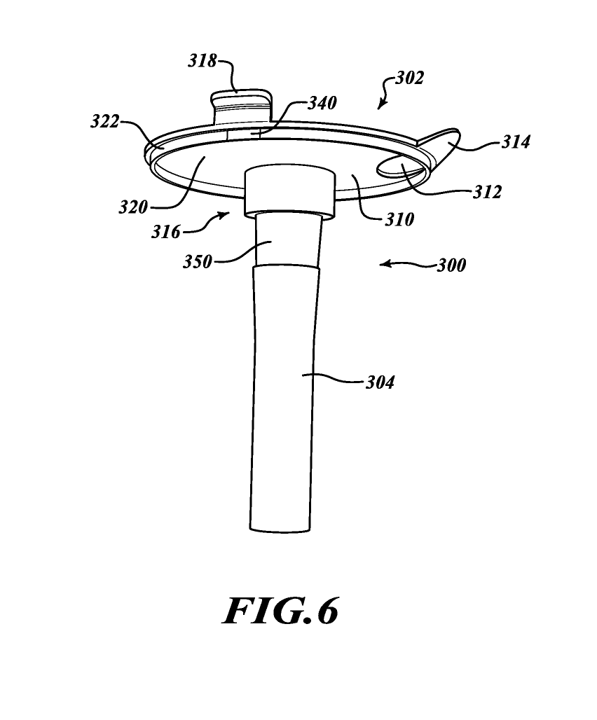

With reference to FIGS. 5 and 6, a container adapter 300 is illustrated. The container adapter 300 can comprise a lid portion 302 and a supply tube 304. In one example, the lid portion 302 and the supply tube 304 can be discrete components that can be coupled to one another, but it will be appreciated in light of the disclosure that the lid portion 302 and the supply tube 304 can also be integrally formed.

With reference to FIGS. 5, 6, and 7, the lid portion 302 can comprise a lid flange 310, a pour port 312, a pour spout 314, a fill port 316, and a decoupling handle 318. In one example, the lid portion 302 can be unitarily formed in a suitable process, such as injection molding, but it will appreciated in light of the disclosure that the lid portion 302 can also be formed of two or more components.

The lid flange 310 can comprise a generally planar lid member 320 and a circumferentially extending sealing rim 322. The lid member 320 can be configured to cover all or a portion of an opening 330 in a container 332 that holds paint (or other suitable liquid) that is to be dispensed by the sprayer 100. The sealing rim 322 of the container adapter 300 can be configured to engage the container 332 (e.g.: a paint can) when the lid portion 302 is secured to the container 332. In this regard, leakage can be avoided between the lid flange 310 and the top of the container 332 when liquid is poured from the container 332. In the various examples, the container 332 can be a conventionally-shaped and constructed one-gallon pail (e.g.: a pail that holds a gallon of paint) having an annular top rim 336 that can define the opening 330. In this arrangement, the sealing rim 322 can be configured to engage the inside diameter of the annular top rim 336.

The lid flange 310 can include one example of means for securing the lid member 320 to the container 332. The means for securing the lid member 320 to the container 332 include a plurality of resilient tabs 340 that are formed into the sealing rim 322. The resilient tabs 340 can be configured to deflect radially inwardly in response to contact with the annular top rim 336 when the lid flange 310 is seated against the top of the container 332 and thereafter disengage and release (or snap back) against the underside of the annular top rim 336. The resilient tabs 340 can form pivoting hooks that can be employed to releasably secure the lid flange 310 to the top of the container 332. It will be appreciated in light of the disclosure that the means for securing the lid flange 310 to the sealing rim 322 can be tailored to the particular type of container that is employed and as such, the particular examples provided are not to be interpreted as limiting the scope of the present teachings.

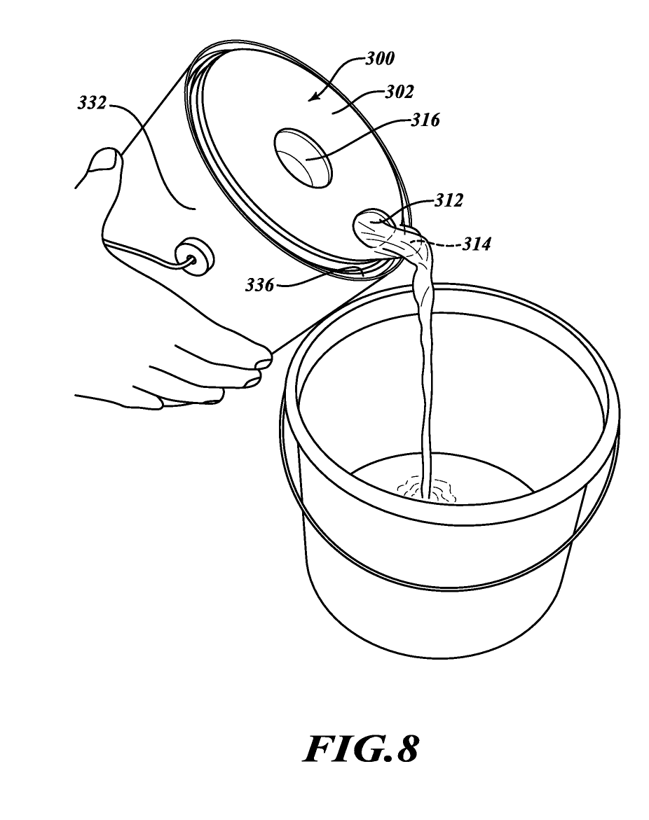

The pour port 312 can comprise an aperture that can be formed through the lid member 320 proximate a radially outward edge of the lid flange 310. The pour spout 314 can be an arcuate or angular structure (e.g.: V-shaped) that can be coupled to the lid member 320 proximate the pour port 312. With reference to FIG. 8, the pour spout 314 can extend outwardly and upwardly from the lid member 320 and can be configured to cooperate with the pour port 312 to aid in controlling a stream of paint (or other suitable liquid) dispensed from the container 332 through the pour port 312. Preferably, the pour spout 314 can extend radially outwardly from the lid member 320 to an extent where liquid dispensed from the container 332 through the pour port 312 does not contact the container 332, e.g.: the annular top rim 336.

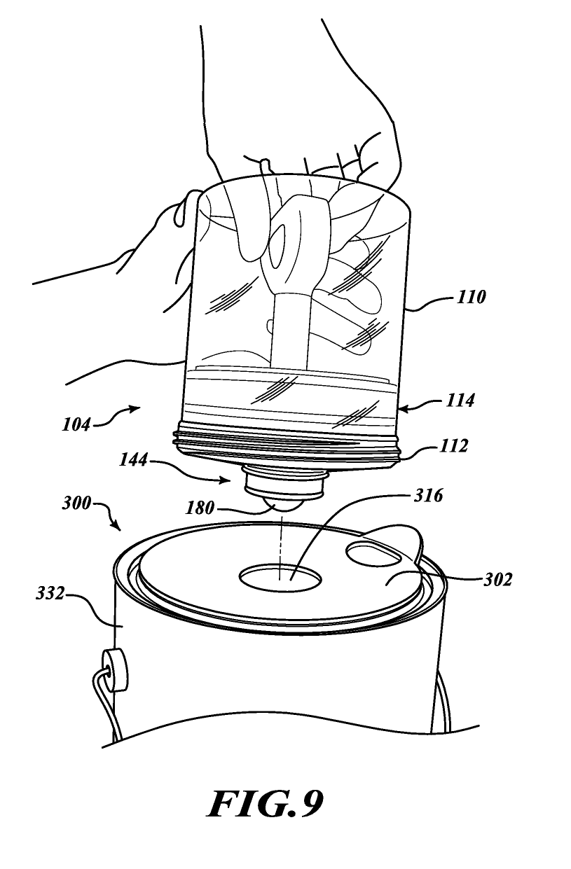

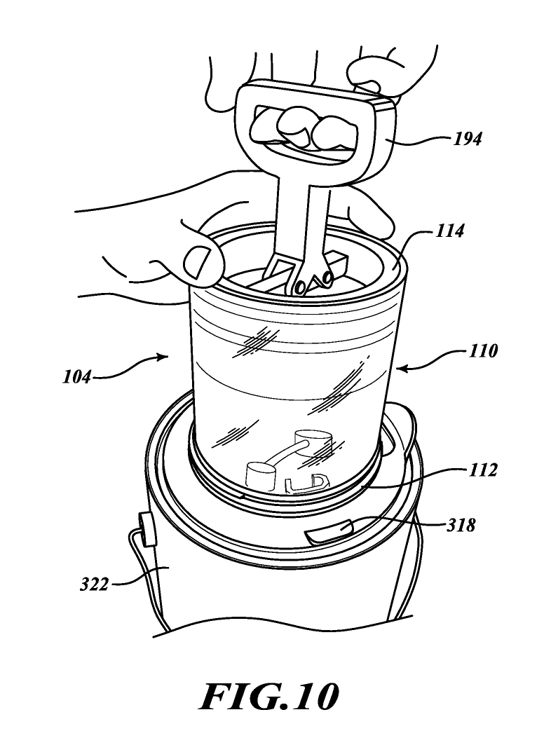

With reference to FIGS. 5-10, the fill port 316 can be a hollow structure that can include an annular side wall 350 that can define an interior surface 352 that can be configured to engage the coupling neck 144 of the reservoir 104. The fill port 316 can include a valve opening feature that can be configured to contact the valve element 180 and urge the valve element 180 away from the valve seat 184. The fill port 316 and the coupling neck 144 can be configured such that the valve element 180 can contact the valve opening feature each time the coupling neck 144 is inserted into the fill port 316. In another instance, contact between the valve element 180 and the valve opening feature can occur only when the coupling neck 144 is oriented in a predetermined position relative to the fill port 316. In these arrangements, the valve assembly 112 can be opened automatically upon engagement of the reservoir 104 to the lid portion 302.

The decoupling handle 318 can be coupled to the lid flange 310 at an appropriate location and can be employed to remove (or pry) the lid member 320 away from the container 332 so as to remove the lid portion 302 from the container 332.

The supply tube 304 can be a generally tubular structure that can be engaged to the fill port 316 (e.g.: with a friction fit, or threads). The supply tube 304 can effectively extend the fill port 316 to a location proximate the bottom of the container 332. To fill the reservoir 104, the supply tube 304 can be coupled to the fill port 316 and the lid portion 302 can be secured to the container 332 such that a bottom end of the supply tube 304 can be disposed below the upper level of the liquid in the container 332.

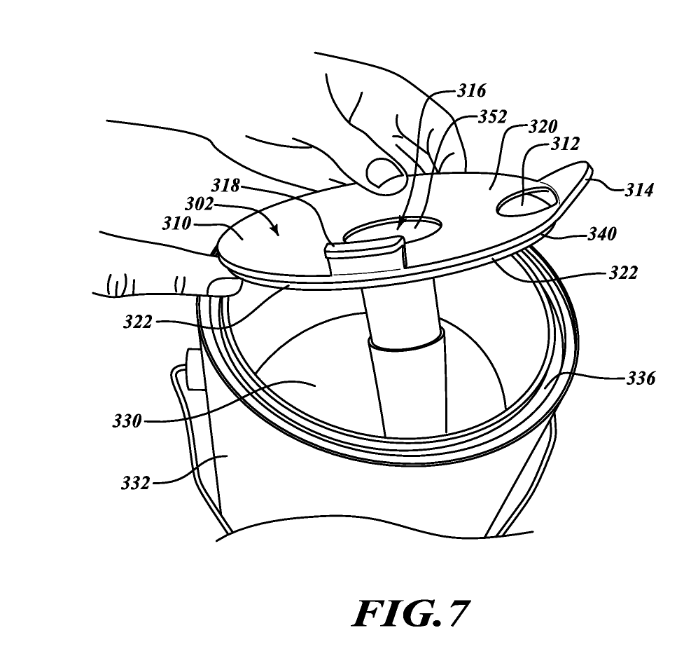

With reference to FIGS. 7, 8, 9, and 10, the piston assembly 114 can be urged upwardly in the cylinder 110 toward the upper cap member 122 to purge air from the interior of the cylinder 110. When the valve element 180 is not biased into the closed position (e.g.: with a spring), the reservoir 104 can be oriented in an upright condition (i.e., with the coupling neck 144 pointing upwardly) while the piston assembly 114 is moved toward the upper cap member 122. Additionally or alternatively, the reservoir 104 can be equipped with a vent system (not shown) that permits the operator to move the valve element 180 away from the valve seat 184 (FIG. 3) or to open another valve (not shown), such as a valve that is incorporated into the piston 190 to relieve air from the interior of the cylinder 110 as the piston assembly 114 is moved toward the upper cap member 122.

With reference to FIGS. 7-10, the coupling neck 144 of the reservoir 104 can be inserted into and engaged to seal with the fill port 316. The handle 194 of the piston assembly 114 can be drawn at an applicable pace away from the upper cap member 122. This in turn can draw liquid in the container 332 up through the supply tube 304 (FIG. 6), the fill port 316, the coupling neck 144, and into the interior of the cylinder 110. It will be appreciated in light of the disclosure that some air may be drawn into the cylinder 110 as the reservoir 104 is filled. In situations where the valve element 180 is not biased into the closed position, the weight of the liquid in the reservoir 104 can close the valve element 180 against the valve seat 184 so the reservoir 104 can be removed from the fill port 316 and turned upright to permit the air to be purged from the interior of the cylinder 110. The air can be purged by urging the piston assembly 114 toward the upper cap member 122. In instances where the valve element 180 is biased into the closed position, the vent system can be employed to open the valve element 180 and/or another valve to permit air to be purged from the interior of the cylinder 110.

The reservoir 104 can be coupled to the sprayer body 102 to provide paint to the sprayer 100. During operation, blowback (from the pumping action) can be routed to a supply conduit to maintain a relatively high degree of suction at the coupling neck 144, which in turn tends to draw the piston assembly 114 upward in the cylinder 110 as liquid is drawn from the cylinder 110. The seal members 192 on the piston assembly 114 can wipe (or wipe clean) the interior surface of the cylinder 110 as the piston assembly 114 translates so as to permit the operator of the sprayer to visually determine the amount of liquid within the cylinder 110.

It will be appreciated that the container adapter 300 can have utility beyond its use with the sprayer 100 and as such, it may be modified somewhat from that which is illustrated in FIGS. 5-10. Specifically, the fill port 316 can be omitted from the lid portion 302 and the supply tube 304 can be omitted altogether, as applicable.

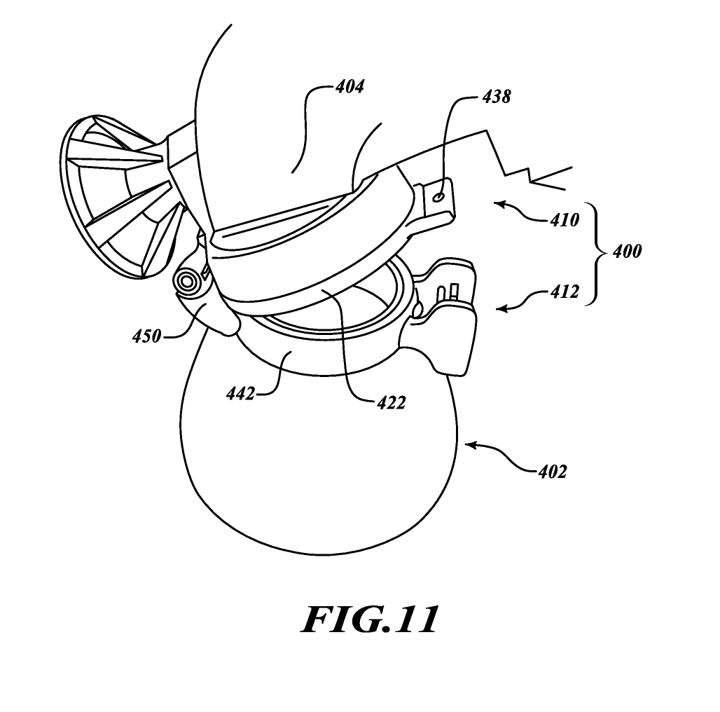

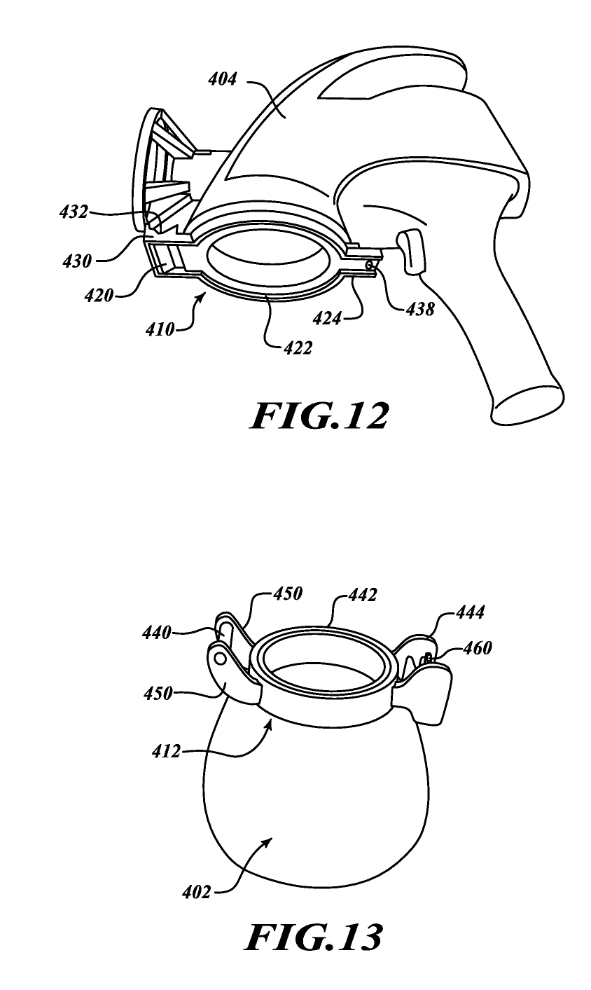

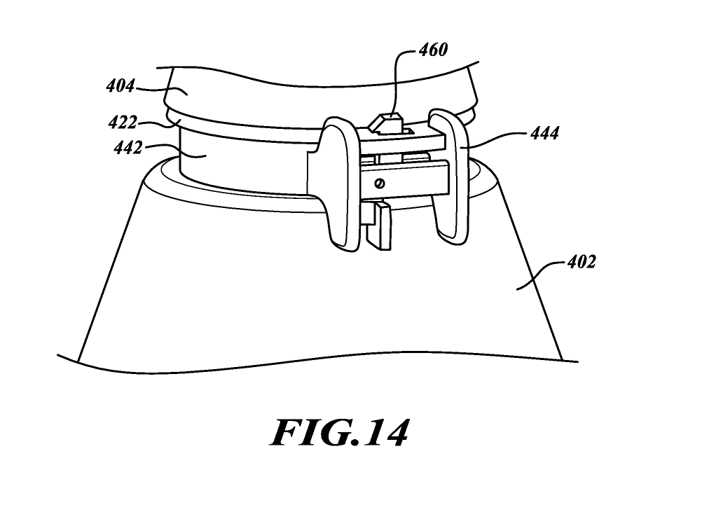

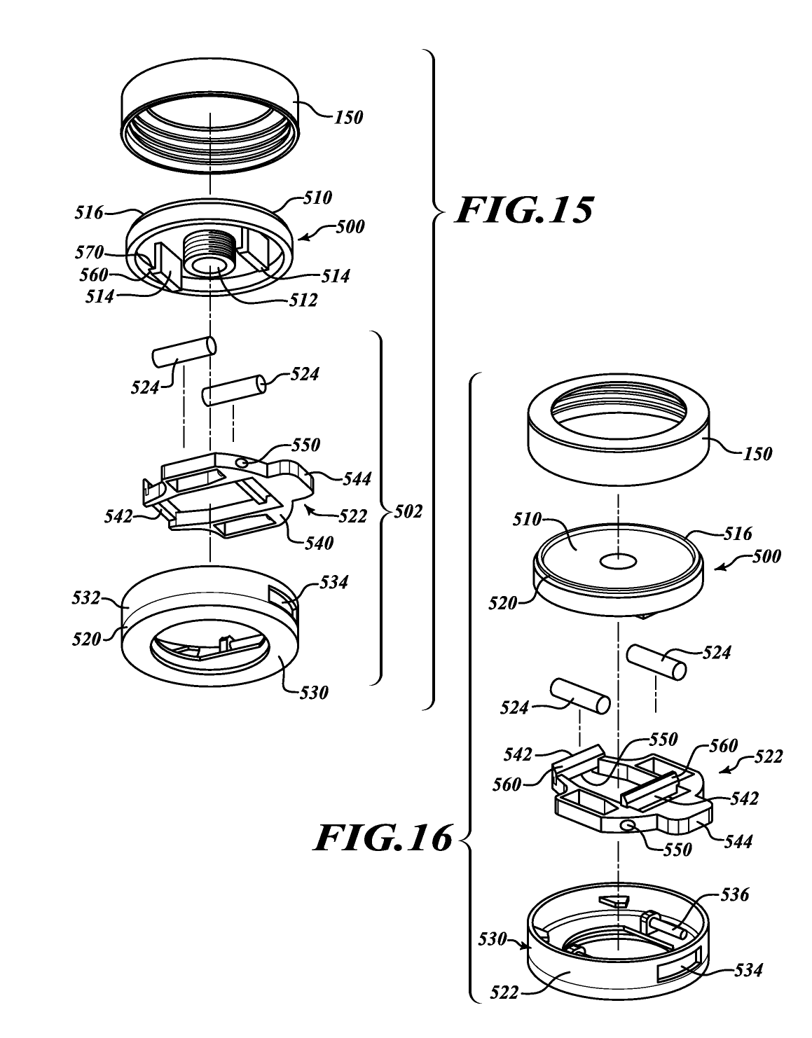

The reservoir 104 has been described as being removably coupled to the sprayer body 102 using a threaded connection. Additional examples of other means for coupling a reservoir to a sprayer body can be employed, as illustrated in FIGS. 11-16. A latch system 400, for example, can be employed to couple a reservoir 402 to a sprayer body 404, as shown in FIGS. 11-14. The latch system 400 can comprise a first latch portion 410, which can be coupled to the sprayer body 404, and a second latch portion 412 that can be coupled to the reservoir 402.

With continuing reference to FIGS. 11-14, the first latch portion 410 can comprise a yoke 420, a first sealing flange 422, and a first latch member 424. The yoke 420 can comprise a saddle 430 having an arcuate saddle surface 432. The first sealing flange 422 can be coupled between the yoke 420 and the first latch member 424. In one example, the first latch member 424 comprises a tab that defines having a latch aperture 438.

The second latch portion 412 can comprise a pivot 440, a second sealing flange 442, and a second latch member 444. The pivot 440 can be a cylindrically shaped structure that can be coupled to the second sealing flange 442 via a pair of arms 450. The yoke 420 can be received between the arms 450 such that the arcuate saddle surface 432 can pivot or rotate on the exterior surface of the pivot 440. The second sealing flange 442 can be configured to engage the first sealing flange 422 and when desired, a gasket (not shown) can be disposed between the first and second sealing flanges 422 and 442 to form a seal therebetween. The second latch member 444 can comprise a resilient tab member 460 that can be deflected to be received through the latch aperture 438 and thereafter released to abut against the first latch member 424 to inhibit relative pivoting movement about the pivot 440 between the first and second latch portions 410 and 412.

With reference to FIGS. 1, 2, 15, and 16, another example of a means for coupling a reservoir to a sprayer body is illustrated. The means for coupling can comprise a collar 150, a sprayer adapter 500, and a coupler 502 that can be configured to be mounted to the reservoir 104 (FIG. 2). The sprayer adapter 502 can comprise a plate member 510, a coupling nipple 512, and a pair of coupling arms 514. The plate member 510 can comprise a plurality of threads 516 that can be threadably engaged to the threads of the collar 150 to fixedly but removably attach the sprayer adapter 500 to the sprayer body 102 (FIG. 1). The coupling nipple 512 can be configured to engage an inlet 162 of the pump assembly 164 (FIG. 1) when the sprayer adapter 500 is coupled to the sprayer body 102. The coupling arms 514 can be hook-like in shape and can extend from the plate member 510 on a side opposite the collar 150.

The coupler 502 can comprise a coupler body 520, a coupler member 522, and a means for biasing the coupler member 522 relative to the coupler body 520, such as a pair of helical compression springs 524. The coupler body 520 can be an annular structure that can be fixedly coupled to the upper cap member 122 (FIGS. 2 and 3) of the reservoir 104. The coupler body 520 can comprise a bottom plate 530, and an annular wall 532 that is coupled to and extends circumferentially around the bottom plate 530. The coupler body 520 can also comprise a slotted aperture 534 that can be formed in the annular wall 532, and a pair of guide pins 536. The annular wall 532 can be configured to engage the perimeter of the plate member 510 to align the coupling neck 144 (FIGS. 2 and 3) to the coupling nipple 512. The coupler body 520 and the sprayer adapter 500 can be keyed to one another to control and fix the orientation of the coupler 502 as it is installed to the sprayer adapter 500. Additionally or alternatively, indicia can be employed on the sides of the coupler body 520 and the sprayer adapter 502 to assist the user of the sprayer to properly orient the coupler 504 to the sprayer adapter 502.

The coupler member 522 can comprise a body 540, a pair of mating coupling arms 542, and a tongue 544. The body 540 can define a pair of apertures 550 for receiving the guide pins 536, and a pair of spring apertures 552 that can be configured to receive the helical compression springs 524. The mating coupling arms 542 can be fixedly coupled (e.g., integrally formed with) the body 540 and can be configured to be engaged to or disconnected from the coupling arms 514 of the sprayer adapter 500 to fix the coupler member 522 to the sprayer adapter 500. The tongue 544 can be received through the slotted aperture 534. The guide pins 536 of the sprayer adapter 502 can be received in the apertures 550. The helical compression springs 524 can be fitted over the guide pins 536 and can be disposed in the spring apertures 552. The helical compression springs 524 can urge the coupler member 522 in a direction relative to the sprayer adapter 500 such that the tongue 544 can extend (or extend further) out of the slotted aperture 534.

To couple the reservoir 104 to the sprayer body 102, the annular wall 532 can be fitted to the perimeter of the plate member 510 to align the coupling neck 144 (FIGS. 2 and 3) to the coupling nipple 512. The tongue 544 can be pressed toward the coupler body 520 to retract the coupler member 522 within the coupler body 520. In the retracted position, the coupler 502 can be fitted to the sprayer adapter 500 such that the mating coupling arms 542 do not engage the coupling arms 514.

In one example, the coupling neck 144 (FIGS. 2 and 3) can engage the coupling nipple 512 prior to the point at which the mating coupling arms 542 can contact the coupling arms 514. The mating coupling arms 542 and the coupling arms 514 can include tapered surfaces 560 that can engage one another to urge the coupler member 522 relative to the sprayer adapter 500 to permit the mating coupling arms 542 to pass beyond the coupling arms 514. When the coupler 502 is fully inserted to sprayer adapter 500, the coupler member 522 can be released to permit the helical coil springs 524 to urge the coupler member 522 outwardly from the coupler body 520 such that confronting surfaces 570 on the coupling arms 514 and the mating coupling arms 542 engage one another. In this arrangement, the coupler member 522 can also inhibit rotation of the coupler 504 relative to the sprayer adapter 502 to inhibit the removal of the reservoir 104, 402 from the sprayer body 102, 404.

The foregoing description of the various aspects of the present teachings has been provided for purposes of illustration and description. It is not intended to be exhaustive or to limit the present teachings. Individual elements or features of a particular aspect of the present teachings are generally not limited to that particular aspect, but, where applicable, are interchangeable and can be used in various selected aspects, even if not specifically shown or described. The same may also be varied in many ways. Such variations are not to be regarded as a departure from the present teachings, and all such modifications are intended to be included within the scope of the present teachings.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A sprayer that delivers a pattern of paint that can be obtained from a container, the sprayer comprising:
a sprayer body that emits the pattern with the paint; and
a reservoir including a cavity that when connected thereto provides the paint to said sprayer body, said reservoir includes a cylinder and a piston assembly manually movable in said cylinder to draw the paint into said cylinder when said reservoir is connected to the container.

2. The sprayer of claim 1 further comprising means for coupling said reservoir to said sprayer body that permits said reservoir to be connected to said sprayer body without rotating said reservoir relative to said sprayer body.

3. The sprayer of claim 3, wherein said means for coupling said reservoir to said sprayer body permits said reservoir to be pivoted relative to said sprayer body.

4. The sprayer of claim 1, wherein said sprayer body includes a collar having an inlet and a threaded periphery, said reservoir includes a cap member, said cap member including a threaded exterior mount and a coupling neck, said coupling neck including an annular seal.

5. The sprayer of claim 4, wherein said annular seal on said coupling neck is configured to be drawn into engagement with said inlet when said threaded exterior mount is threaded on said threaded periphery of said collar.

6. The sprayer of claim 4 further comprising a container adapter configured to seal to an inner periphery of the container, said container adapter including a fill port configured to seal to said coupling neck on said cap member.

7. The sprayer of claim 6, wherein said container adapter includes a pour port and a decoupling handle configured to be used to break a seal between said container adapter and the container to which it is attached.

8. The sprayer of claim 6, wherein said container adapter includes a pour port and a pour spout that extends from said pour port to a location radially outward from an outer periphery of the container.

9. The sprayer of claim 6, wherein said container adapter includes a lid flange having a circumferentially extending rim including means for securing said lid flange to said inner periphery of the container.

10. The sprayer of claim 1, wherein said reservoir includes a valve assembly that selectively vents air from the reservoir.

11. The sprayer of claim 10 further comprising a cap member operable to couple to said cylinder, said cap member having at least a partial frusto-conically shaped interior surface to direct air in said cylinder toward a coupling neck that extends from said cap member and is operable to connect to said sprayer body.

12. The sprayer of claim 10 further comprising a cap member operable to couple to said cylinder and a valve assembly connected to said cap member, said valve assembly having a valve element and an elastic element that biases said valve element to close the valve assembly unless said reservoir is fluidly connected to said sprayer body.

13. The sprayer of claim 10 further comprising a cap member operable to couple to said cylinder and a valve assembly connected to said cap member, said valve assembly having a valve element operable to close the valve assembly when urged by the paint.

14. A container adapter that can connect to a container of paint to provide the paint to a sprayer, the container adapter comprising:
a lid member;
a pour port formed through said lid member;
a pour spout coupled to said lid member proximate said pour port; and
a fill port that is adapted to be engaged by a reservoir that is operable to provide the paint to a sprayer body when connected to the sprayer, said reservoir including a piston assembly that draws liquid through said fill port into said reservoir when connected to said fill port of the container adapter that is connected to the container.

15. The container adapter of claim 14 further comprising a decoupling handle that extends from said lid member and is configured to be used to break a seal between the container adapter the container.

16. The container adapter of claim 14, wherein said pour spout extends from said pour port to a location radially outward from an outer periphery of the container.

17. The container adapter of claim 14, wherein said lid member includes a lid flange having a circumferentially extending rim including means for securing said lid flange to an inner periphery of the container.

18. A method of providing paint to a sprayer from a reservoir that can be connected to a container of the paint with a container adapter and can be connected to a sprayer body of the sprayer, the method comprising:
sealing the container adapter to the container holding the paint;
sealing the reservoir to the container adapter connected to the container;
drawing the paint from the container through the container adapter and into a cavity in the reservoir by moving a handle associated with the reservoir relative to its cylinder structure;
disconnecting the reservoir from the container adapter; and
sealing the reservoir to the sprayer body of the sprayer.

19. The method of claim 18 further comprising moving the handle relative to the cylinder structure of the reservoir in a direction opposite from drawing the paint into the reservoir to discharge air from the reservoir through a valve assembly.

20. The method of claim 18 wherein the sealing of the reservoir to the sprayer body of the sprayer includes threading a cap member on the reservoir to a collar on the sprayer body to establish a seal between the sprayer body and the reservoir.
